(19) United States
(12) Patent Application Publication
(10) Pub. No.: US 2010/0031807 A1
(43) Pub. Date: Feb. 11, 2010

(54) Chambered Electric Guitar

(75) Inventors: Daniel Fiocco, Montreal (CA); Yves Vezina, La Patrie (CA)

Correspondence Address: K&L Gates LLP, STATE STREET FINANCIAL CENTER, One Lincoln Street, BOSTON, MA, 02111-2950, US

(73) Assignee: 117506 CANADA INC., Baie d'Urfe (CA)

(21) Appl. No.: 12/188,699

(22) Filed: Aug. 8, 2008

(51) Int. Cl. G10H 1/32

(52) U.S. Cl. 84/743

(57) ABSTRACT

A chambered electric guitar according to an illustrative embodiment of the present invention includes at least one tone chamber that is linked to the external world only via a pick-up cavity of the guitar. Vibration of the strings of the guitar generates a vibration of the air in the tone chamber. This air vibration moves the air in and out of the tone chamber via the pick-up cavity. This air movement in the vicinity of the pick-up moves the pick-up as a whole and/or moves some portions of the pick-up. This pick-up movement changes the sound of the guitar.

### FIELD

The present invention generally relates to electric guitars. More specifically, the present invention is concerned with an electric guitar provided with at least one tone chamber.

### BACKGROUND

Chambered electric guitars are known in the art. Some known chambered guitars are provided with internal tone chambers that are completely embedded in the instrument in view of reducing the overall weight of the guitar. These chambered guitars are not provided with sound ports to allow air and sound exchange between the chambers and the external world.

Another type of chambered electric guitar is provided with at least one tone chamber that has a sound port, generally used to increase the acoustic volume of the electric guitar when played unplugged.

### BRIEF DESCRIPTION OF THE DRAWINGS

In the appended drawings:

FIG. 1 is a perspective view of the core portion of the body of a chambered electric guitar according to an illustrative embodiment of the present invention;

FIG. 2 is an exploded perspective view of the chambered electric guitar body of FIG. 1, viewed from the top;

FIG. 3 is an exploded perspective view of the chambered electric guitar body of FIG. 1, viewed from the rear;

FIG. 4 is a top plan view of the core portion of the chambered guitar body of FIG. 1;

FIG. 5 is a top plan view of the assembled chambered guitar body of FIG. 1; and

FIG. 6 is a sectional view taken alone line 6-6 of FIG. 5.

### DETAILED DESCRIPTION

In accordance with an illustrative embodiment of the present invention, there is provided a chambered body for an electric guitar comprising:

a core portion defining a body shape; the core portion including:
at least one pick-up cavity configured and sized to receive a pick-up;
at least one tone chamber;
at least one tone channel interconnecting the at least one tone chamber to the at least one pick-up cavity;

a cover portion to be mounted to the core portion; the cover portion being so configured and sized as to close the at least one tone chamber.

According to another aspect of the present invention, there is provided a chambered core portion of an electric guitar defining a body shape; the core portion including:
at least one pick-up cavity configured and sized to receive a pick-up;
at least one tone chamber; and
at least one tone channel interconnecting the at least one tone chamber to the at least one pick-up cavity.

According to another aspect of the present invention, there is provided an electric guitar comprising:

a chambered body including:
a core portion defining a body shape; the core portion including:
   at least one pick-up cavity configured and sized to receive a pick-up;
   at least one tone chamber;
   at least one tone channel interconnecting the at least one tone chamber to the at least one pick-up cavity;
a cover portion to be mounted to the core portion; the cover portion being so configured and sized as to close the at least one tone chamber; and

a neck mounted to the chambered body.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

It is to be noted that the expression “external world” is to be construed herein and in the appended claims as everything that is external to a guitar.

Other objects, advantages and features of the present invention will become more apparent upon reading of the following non-restrictive description of illustrative embodiments thereof, given by way of example only with reference to the accompanying drawings.

Generally stated, a chambered electric guitar according to an illustrative embodiment of the present invention includes at least one tone chamber that is linked to the external world only via at least one pick-up cavity of the guitar. Vibration of the strings of the guitar generates a vibration of the air in the tone chamber. This air vibration moves the air in and out of the tone chamber via the pick-up cavity. This air movement in the vicinity of the pick-up moves the pick-up as a whole and/or moves some portions of the pick-up. This pick-up movement changes the sound properties of the guitar by changing subtle microphonic properties of the pick-up.

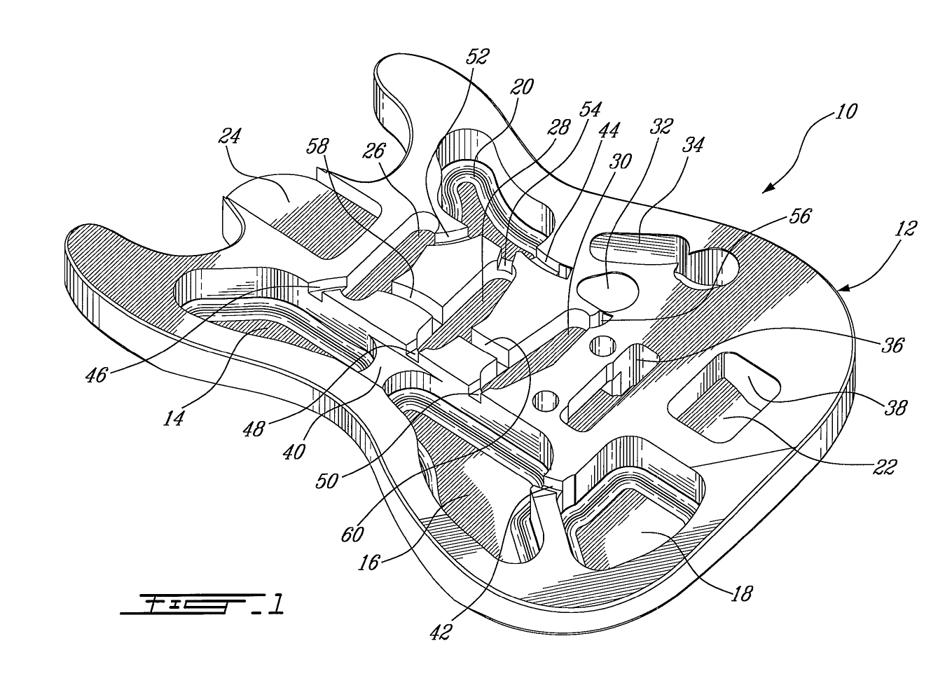

Turning now to FIGS. 1 to 6, a chambered body 10 of an electric guitar will be described.

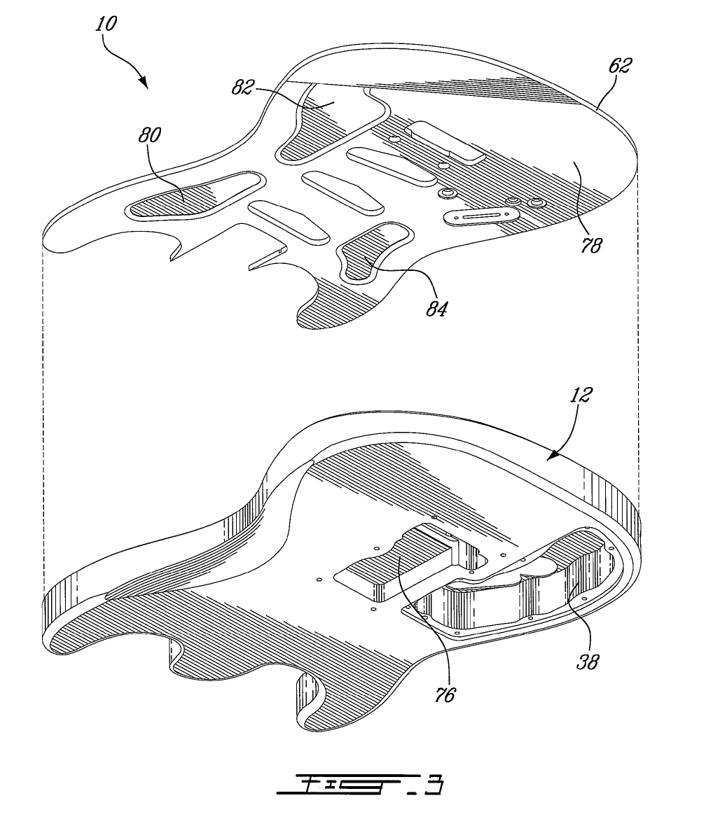

FIG. 1 illustrates the core 12 of the chambered body 10. The core 12 includes five tone chambers 14 to 22, a neck-receiving pocket 24, three pick-up cavities 26 to 30, two electronic-receiving pockets 32 and 34 and a bridge cavity 36. As can be better seen from FIG. 3, the back of the core 12 is routed to form an electronic cavity 38 interconnecting the two electronic-receiving pockets 32 and 34.

The core 12 also includes a plurality of tone channels interconnecting the tone chambers and connecting the tone chambers to the pick-up cavities. More specifically, the core 12 includes:
a tone channel 40 interconnecting the tone chamber 14 to the tone chamber 16;
a tone channel 42 interconnecting the tone chamber 16 to the tone chamber 18;
a tone channel 44 interconnecting the tone chamber 20 to the electronic cavity 38;
a tone channel 46 interconnecting the tone chamber 14 to the pick-up cavity 26;
a tone channel 48 interconnecting both tone chambers 14 and 16 to the pick-up cavity 28;
a tone channel 50 interconnecting the tone chamber 16 to the pick-up cavity 30;
a tone channel 52 interconnecting the tone chamber 20 to the pick-up cavity 26;
a tone channel 54 interconnecting the tone chamber 20 to the pick-up cavity 28; and
a tone channel 56 interconnecting the electronic cavity and the tone chamber 22 to the pick-up cavity 30.

Pick-up wire channels 58 and 60 are also conventionally provided between the pick-up cavities 26, 28 and 30. The tone channel 56 also doubles as a pick-up wire channel to allow the pick-up wires to reach the electronics cavity 38.

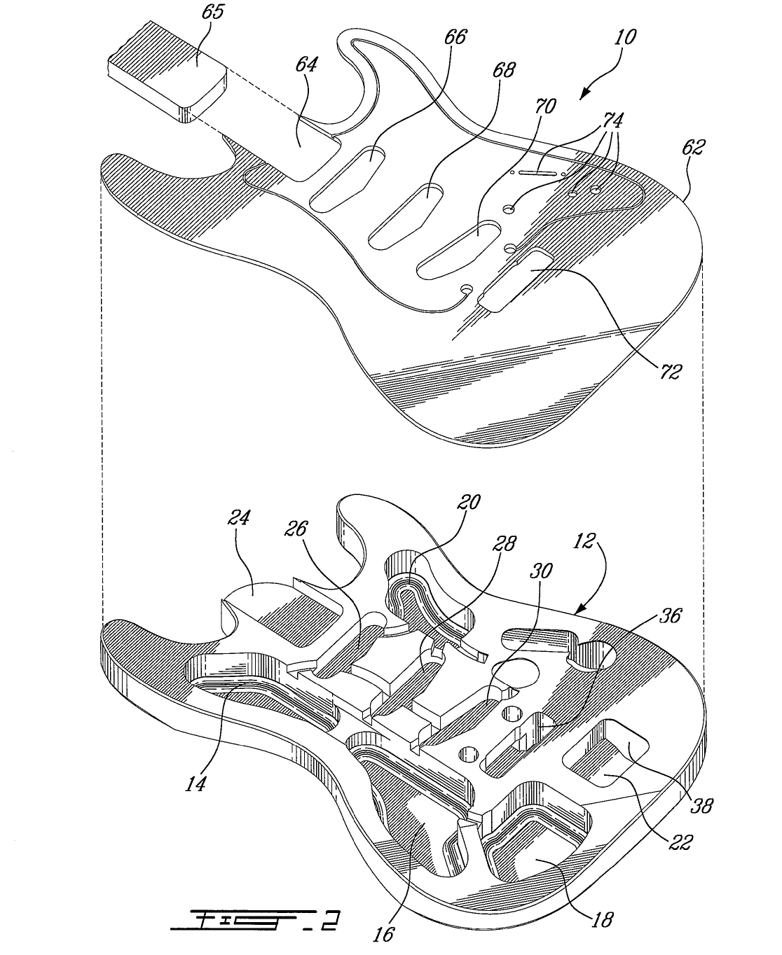

Turning now to FIG. 2, the top portion 62 to be adhered to the core 12 to form the chambered guitar body 10 will be described.

The top portion 62 generally has the same body shape as the core 12, has an inner surface to be adhered to the core 12 and includes a neck receiving cut-out 64 corresponding to the neck pocket 24, three pick-up apertures 66 to 70 respectively corresponding to the three pick-up cavities 26 to 30, a bridge aperture 72 corresponding to the bridge cavity 36 and other smaller apertures 74 to accommodate the electronics controls of the guitar.

As will easily be understood by one skilled in the art, when the top portion 62 is adhered to the core 12, for example by using an appropriate glue, the tone chambers 14, 16, 18, 20 and 22 are closed and their only contact with the external world is from the pick-up cavities 26, 28 and 30 that are still open to the external world thanks to the apertures 66, 68 and 70. The top portion 62 may therefore be viewed as a cover covering the tone chambers.

As can be seen from FIG. 3, the back of the core 12 includes the electronics cavity 38 and a conventional spring receiving cavity 76. Also from FIG. 3, it can be seen that the underside 78 of the top portion 62 includes three recessed areas 80, 82 and 84 generally corresponding to the tone chambers 14, 16 and 20, respectively. The purpose of these recessed areas is generally to increase the volume of the tone chambers 14,16 and 20.

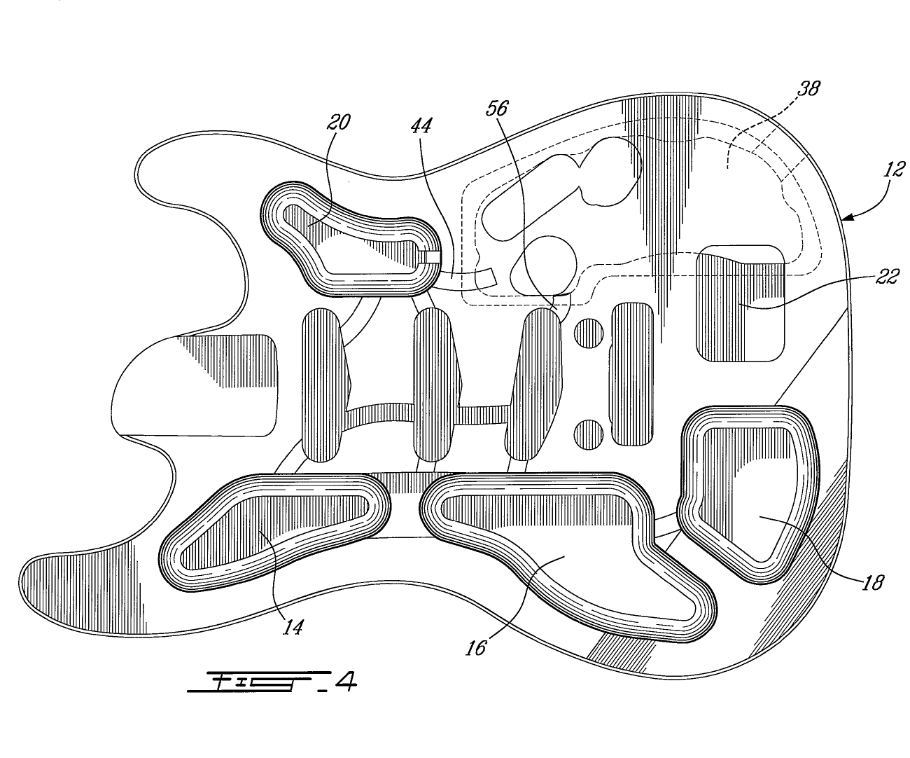

FIG. 4, which is a top plan view of the core 12, better shows the interconnection between the tone chambers via the tone channels. The electronics cavity 38 is shown in dashed lines in FIG. 4 to better illustrate the interconnection of the electronics cavity 38 with the other tone chambers 20 and 22.

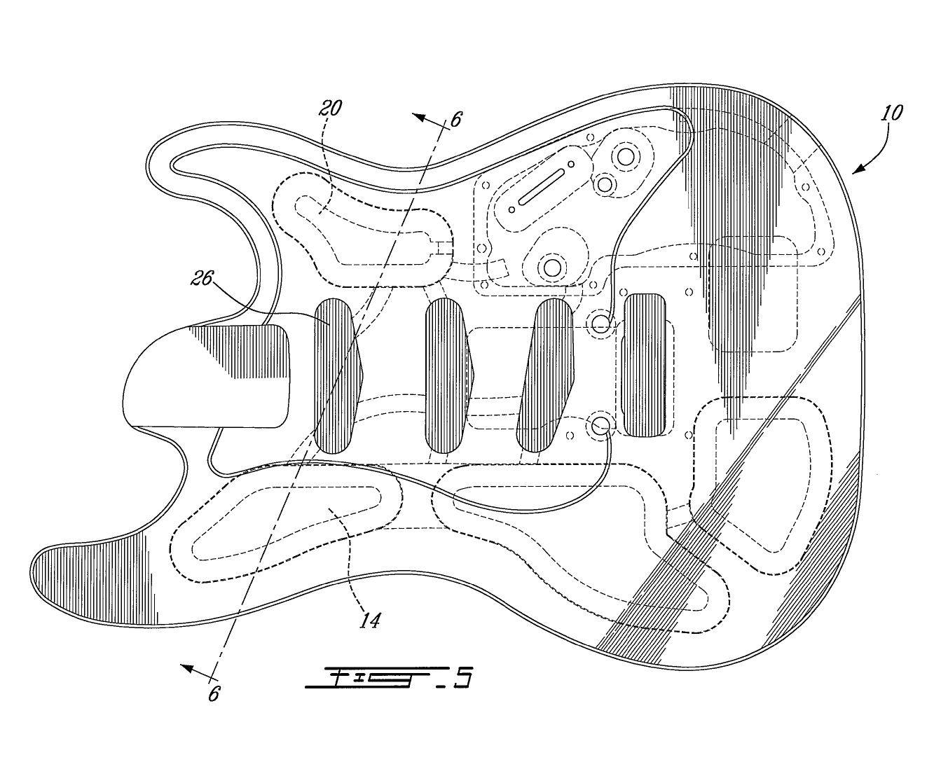

FIG. 5 is a top plan view of the assembled body 10.

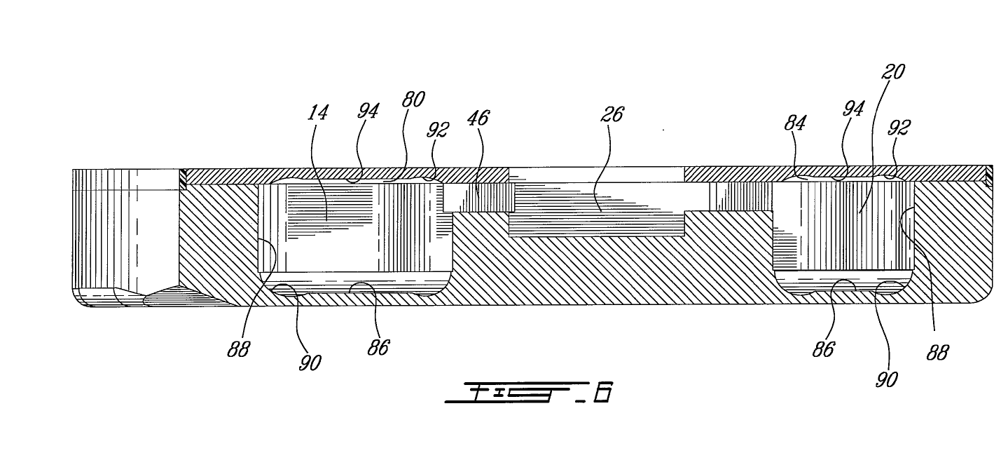

As can be seen from FIG. 6, which is a sectional view taken along line 6-6 of FIG. 5, the junctions 90 of the bottom walls 86 to the peripheral walls 88 of the cavities are rounded and go slightly deeper than the bottom wall 86 itself. This configuration weakens the periphery of the bottom wall without removing mass from the center of the bottom wall, which increases the vibrations of the tone chambers.

FIG. 6 also shows that the recessed areas 80-84 of the top portion 62 are also provided with rounded junctions 92 that go slightly deeper than the central portions 94 thereof for the same reason described hereinabove.

As will easily be understood by one skilled in the art, the various tone chambers 14-22 have different air volumes and plan surfaces where they interact with the top portion 62. Accordingly, the tone chambers have different frequency range at which they vibrate and may be viewed as pumping the air in and out of the pick-up cavities 26-30. It is therefore possible to “tune” the volume and plan surface of the tone chambers according to the desired acoustic characteristics of the guitar.

As mentioned hereinabove, the vibration of the strings of the guitar generates a vibration of the air in the tone chambers. This air vibration moves the air in and out of the tone chamber via the pick-up cavities since the pick-up cavities are the only aperture between the tone chambers and the external world. The air movement in the vicinity of the pick-up moves the pick-up as a whole and/or moves some portions of the pick-up. This total or partial pick-up movement changes the sound properties of the guitar by changing subtle microphonic properties of the pick-up.

It is also to be noted that the air vibration in the tone chambers, caused by the vibration of the strings (not shown) also causes the body to vibrate more than would vibrate a conventional so called “solid body” guitar. This vibration of the body causes the bridge (not shown) installed in the bridge cavity 36 to vibrate and to transfer a portion of this vibration to the already vibrating strings. There is therefore a decaying loop between the vibrating strings and the vibrating air which increases the sustain of the chambered guitar.

It is generally known that the sound signal from an electric guitar is generated by the movement of the metallic strings in the magnetic field of the pick-up. By moving the source of the magnetic field, i.e. the magnet of the pick-up, or the coil of the pick-up, at a frequency that is relevant to the frequency of the vibrating strings, the sound signal coming from the coil of the pick-up is positively modified, thereby modifying the sound properties of the guitar.

While the core portion of the chambered body has been illustrated and described herein as being routed from the top and fitted with a separate top portion, it would be possible to form the tone chambers from the rear face of the core portion and fit it with a back portion closing the tone chambers.

As will easily be understood by one skilled in the art, the body shape, number and position of the tone chambers, number and position of the tone channels and number and position of pick-up cavities illustrated and described herein are for illustration purposes and could be modified at will without departing from the spirit and nature of the present invention.

As will be also apparent to one skilled in the art, the core and top portion of the chambered body may be conventionally made of solid or laminated wood. Other materials can also be used, depending on the desired sound properties of the finished instrument.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A chambered body for an electric guitar comprising:
a core portion defining a body shape; the core portion including:
at least one pick-up cavity configured and sized to receive a pick-up;
at least one tone chamber;
at least one tone channel interconnecting the at least one tone chamber to the at least one pick-up cavity;
a cover portion to be mounted to the core portion; the cover portion being so configured and sized as to close the at least one tone chamber.

2. The chambered electric guitar body recited in claim 1, wherein the cover portion is a top portion of the body.

3. The chambered electric guitar body recited in claim 1, wherein each at least one tone chamber includes a bottom wall and a peripheral wall; the junction of the peripheral wall to the bottom wall being rounded and slightly deeper than the bottom wall.

4. The chambered electric guitar body recited in claim 1, wherein the cover portion includes an inner surface including at least one recess in register with the at least one tone chamber when the inner face of the cover portion is mounted to the core portion.

5. The chambered electric guitar body recited in claim 4, wherein the at least one recess includes a bottom wall and a peripheral wall; the junction of the peripheral wall to the bottom wall being rounded and slightly deeper than the bottom wall.

6. The chambered electric guitar body recited in claim 1, wherein the at least one pick-up cavity includes three pick-up cavities.

7. The chambered electric guitar body recited in claim 1, wherein the at least one tone chamber includes five tone chambers.

8. The chambered electric guitar body recited in claim 4, wherein the at least one recess includes three recesses.

9. A chambered core portion of an electric guitar defining a body shape; the core portion including:
at least one pick-up cavity configured and sized to receive a pick-up;
at least one tone chamber; and
at least one tone channel interconnecting the at least one tone chamber to the at least one pick-up cavity.

10. The chambered core portion recited in claim 9, wherein each at least one tone chamber includes a bottom wall and a peripheral wall; the junction of the peripheral wall to the bottom wall being rounded and slightly deeper than the bottom wall.

11. The chambered core portion recited in claim 9, wherein the at least one pick-up cavity includes three pick-up cavities.

12. The chambered core portion recited in claim 9, wherein the at least one tone chamber includes five tone chambers.

13. An electric guitar comprising:
a chambered body including:
a core portion defining a body shape; the core portion including:
at least one pick-up cavity configured and sized to receive a pick-up;
at least one tone chamber;
at least one tone channel interconnecting the at least one tone chamber to the at least one pick-up cavity;
a cover portion to be mounted to the core portion; the cover portion being so configured and sized as to close the at least one tone chamber; and
a neck mounted to the chambered body.

14. The electric guitar recited in claim 13, wherein the core portion further includes a neck cavity configured and sized to receive the neck.

15. The electric guitar recited in claim 13, wherein the cover portion is a top portion of the body.

16. The electric guitar recited in claim 13, wherein each at least one tone chamber includes a bottom wall and a peripheral wall; the junction of the peripheral wall to the bottom wall being rounded and slightly deeper than the bottom wall.

17. The electric guitar recited in claim 13, wherein the cover portion includes an inner surface including at least one recess in register with the at least one tone chamber when the inner face of the cover portion is mounted to the core portion.

18. The electric guitar recited in claim 17, wherein the at least one recess includes a bottom wall and a peripheral wall; the junction of the peripheral wall to the bottom wall being rounded and slightly deeper than the bottom wall.

19. The electric guitar recited in claim 13, wherein the at least one pick-up cavity includes three pick-up cavities.

20. The electric guitar recited in claim 13, wherein the at least one tone chamber includes five tone chambers.

21. The electric guitar recited in claim 17, wherein the at least one recess includes three recesses.
